(19) United States
(12) Patent Application Publication
(10) Pub. No.: US 2004/0076189 A1
(43) Pub. Date: Apr. 22, 2004

(54) Multiphase clocking method and apparatus

(75) Inventors: David William Boerstler, Round Rock, TX (US); Sang Hoo Dhong, Austin, TX (US); Harm Peter Hofstee, Austin, TX (US); Stephen Douglas Weitzel, Round Rock, TX (US)

Correspondence Address: Gregory W. Carr, 670 Founders Square, 900 Jackson Street, Dallas, TX, 75202, US

(73) Assignee: International Business Machines Corporation, Armonk, NY

(21) Appl. No.: 10/273,641

(22) Filed: Oct. 17, 2002

(51) Int. Cl. H04J 3/06; H04L 27/14

(52) U.S. Cl. 370/516

(57) ABSTRACT

Disclosed is the method of and apparatus for reducing the magnitude of switching occurring at any given time. This is accomplished by grouping circuitry into a plurality of partitions wherein the circuitry in each partition may be operationally switched at times different from circuitry in other partitions. Different phase clock signals are then provided to each partition whereby switching operationally occurs at different times in each of the partitions. An example of circuitry that can utilize this improvement is a main processor or computer utilizing a plurality of auxiliary processor units in its operations.

### TECHNICAL FIELD

The present invention relates in general to reducing instantaneously occurring switching currents.

### BACKGROUND

Traditional microprocessor designs typically utilize synchronous clocking techniques which use a single clock phase that is globally distributed in an isochronous manner so that clock signal skew throughout the electronic package is minimized. Since all of the loads for this global clock are switched at roughly the same time, the simultaneous switching current demands placed on the package and the power distribution design typically will have a significant impact upon parameters or items such as performance, reliability, technology, wireability, yield and cost. The inductive effects that will occur with large switching currents may produce over and/or under voltage transients that contribute to premature failure of various electronic components. Such switching currents may also generate significant signal radiation requiring emission shielding to be incorporated in the electronic package.

Additional information as to the operation of this invention in conjunction with a multiprocessor application may be found in a co-pending application entitled “Microprocessor Chip Simultaneous Switching Current Reduction Method and Apparatus” (Docket No. AUS920020472US1), filed concurrently herewith and incorporated herein by reference for all purposes. The referenced application names the same inventors and is assigned to the same assignee.

It would thus be desirable to reduce the switching current magnitude occurring at any given time and accordingly reduce inductive effects (L) and signal radiation generated with rapid current level changes (di/dt).

### SUMMARY OF THE INVENTION

One or more of the foregoing switching disadvantages are reduced in an electronic package by dividing the package circuitry into a plurality of partitions or sets, each containing circuitry that may be operationally switched at times different from circuitry in other partitions or sets. A multiphase clock generator is used to provide different phase clock signals to each of said plurality of partitions or sets whereby switching operationally occurs at different times in each of the partitions or sets of the electronic package.

### BRIEF DESCRIPTION OF THE DRAWINGS

For a more complete understanding of the present invention, and its advantages, reference will now be made in the following Detailed Description to the accompanying drawings, in which:

FIG. 1 is a block diagram of an exemplary circuit embodying the present invention;

FIG. 2 comprises a set of waveforms used in explaining the operation of FIG. 1; and

FIG. 3 is a block diagram for illustrating one method of obtaining the required differing phase clock signals for use in FIG. 1.

### DETAILED DESCRIPTION

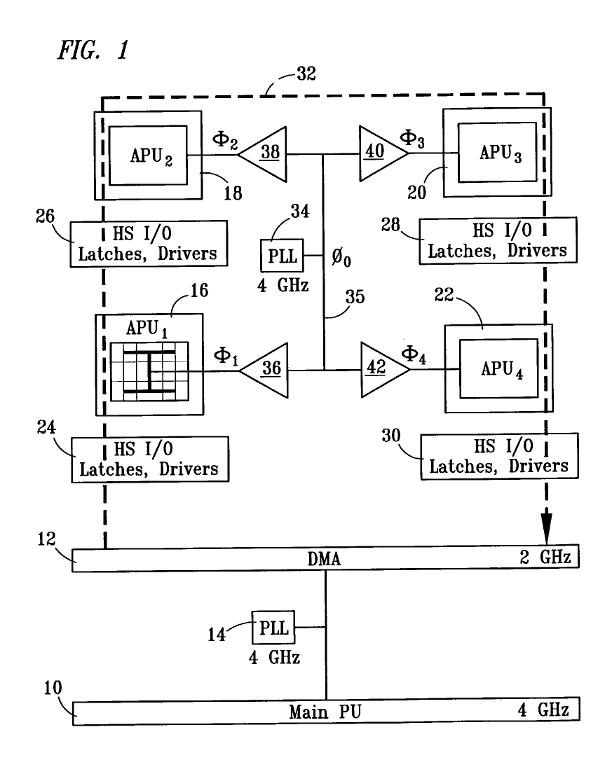

In FIG. 1, a main processing unit (MPU) 10 and a direct memory access unit (DMA) 12 receive clock signal inputs from a phase lock loop (PLL) source 14 which, as shown, provides clock signals at 4 GHz. In a preferred embodiment of the invention, a base reference signal of 1 GHz is used by the PLL block 14 to generate the output clock signal. Also shown in FIG. 1 are auxiliary processing units (APUs) 16, 18, 20 and 22 which are additionally labeled APU₁, APU₂, APU₃ and APU₄, respectively. Each of these APUs has an associated I/O (Input/Output) block for receiving signals from and transmitting signals to the DMA 12.

A first I/O block 24 is associated with APU 16. A second I/O block 26 is associated with APU 18. A third I/O block 28 is associated with APU 20. A fourth and final I/O block 30 is associated with APU 22. Each of the I/O blocks is shown connected to the DMA 12 via a ring type network indicated by a dash line 32. In this manner, each of the APUs may receive the data, operate upon the data (or ignore same) and pass it to the next APU, as appropriate, in consecutive operations wherein each APU is using slightly differently timed switching operations.

A PLL 34, which in some circuit packaging instances may be the PLL 14, uses a base 1 GHz reference signal, identical to that used by PLL 14, to create a 4 GHz signal Ø₀ on a lead 35. This 4 GHz signal is supplied to timing delay circuits 36, 38, 40 and 42. The delay circuit 36 delays the signal Ø₀ in a manner to apply a signal Ø₁ to be used by APU₁ 16. An “H” type signal path is shown internal to block 16 as a bold or wide type circuit path to help reduce any skew of the clock signal as it is distributed to each of the circuits utilizing this clock within APU₁ 16. The delay circuit 38 generates a clock signal Ø₂ for application to APU 18. Although detail is not shown within block 18, it will desirably have some method of minimizing clock skew of the clock signal Ø₂ as it is distributed within APU 18. Similarly, APUs 20 and 22 will typically provide clock skew reducing mechanisms. The delay circuit 40 generates a clock signal Ø₃ for application to APU 20 while delay circuit 42 generates a clock signal Ø₄ for application to APU 22.

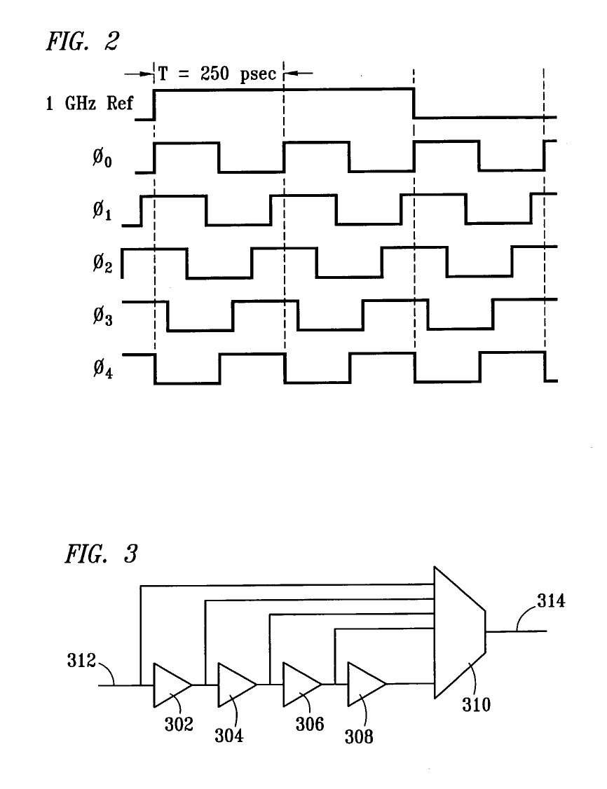

In FIG. 2, the relative phasing of the main 1 GHz reference signal and the generated clock signals Ø₀, Ø₁, Ø₂, Ø₃, and Ø₄ mentioned in conjunction with FIG. 1 are shown. It may be noted that Ø₀ and Ø₄ are 180 degrees out of phase. Thus, the switching currents for the PLLs, as well as for each of the illustrated APUs, occurs at different times, thereby reducing the current required at the appropriate switching time by at least a factor of 4.

FIG. 3 contains a plurality of non-inverting amplifiers 302, 304, 306 and 308 connected in series with the output of each of the amplifiers connected to a multiplexer 310. A clock input 312 to amplifier 302 may be the clock signal Ø₀ as found on lead 35 of FIG. 1. The output of each of the amplifiers 302, 304, 306 and 308 may be delayed, with respect to the input thereof, by ⅞ of a 4 GHz cycle or 218.75 psec (picoseconds). Thus, amplifier 302 may generate signal Ø₁ and supply the same to amplifier 304 for the generation of Ø₂, and so forth. The multiplexer 310 may then be programmed or otherwise set to output a selected one of the five clock signals input thereto. In this manner, the identical circuitry of FIG. 3 may be used to implement each of the delay circuits 36, 38, 40 and 42.

In summary, each of the blocks of FIG. 1 receives current from one or more power supplies (not shown). When a switching action occurs, as activated in part by an accompanying or associated clock signal, changes in current flow (di/dt) occur in the signal transmission paths of appropriate blocks in the electronic package. These changes in current magnitude may cause voltage changes at points in the current path, and the current magnitude affects the amount of signal radiation from the package. Thus, the use of phase differing clock signals, by each of the APUs in the electronic package of circuitry shown in FIG. 1, will reduce the total current needed at any given switch time and reduce the maximum change in current occurring at a given switch time. Such reduction acts to minimize problems occurring from the simultaneous switching of many circuits as has occurred in the prior art.

The various APUs (or a part of the APU) may each be alternatively designated as cores, and the entire APU may alternatively be referred to as an electronic package partition comprising multiple isochronous units. In other words, a given APU will typically be an assembly of many circuits, each requiring switching at substantially the same time as many of the other circuits in that APU.

While the drawings and description, so far, are directed to a single electronic chip containing a plurality of CPUs or computer processors operating or switching at different times in accordance with different phase clocks, the invention is not so restricted. An electronic package comprising a multiplicity of chips, wherein each chip is clocked for operating its switching functions at different times to reduce instantaneous switching current demands on the package, is within the scope of the invention. Whether the switching circuitry of an electronic package is adapted to have different switching times for different chips, different partitions on a single chip or enough different phase clock to have both approaches practiced, the invention is not limited to CPUs and circuitry associated therewith. Any circuitry or electronic package having a large number of devices, which may be switched simultaneously in prior art devices, is contemplated as being included within the present invention. Examples might be crossbar switches and arrays where there are a large number of devices which may switch simultaneously.

Although the invention has been described with reference to a specific exemplary embodiment, these descriptions are not meant to be construed in a limiting sense. Various modifications of the disclosed embodiment, as well as alternative embodiments of the invention, will become apparent to persons skilled in the art upon reference to the description of the invention. It is therefore contemplated that the claims will cover any such modifications or embodiments that fall within the true scope and spirit of the invention.

What is claimed is:

1. A method for reducing simultaneous switching problems in a microprocessor having multiple cores, comprising:
defining a plurality of partitions comprising multiple isochronous units each including one of said cores;
generating a system reference clock signal having an associated clock frequency;
generating, from said reference clock signal, a plurality of related clock signals, each with said clock frequency but a different phase from said reference clock signal, each said related clock signals being associated with a different one of said units; and
operating each of said units with a respective different one of said related clock signals.

2. A method for reducing switching current induced problems in an electronic package, comprising:
grouping at least a portion of the circuitry of the electronic package into a given plurality of partitions; and
applying same frequency but different phase clock signals to each one of said given plurality of partitions whereby switching operationally occurs at different times in each of said partitions.

3. An electronic circuit microprocessor package having multiple cores, comprising:
a plurality of partitions comprising multiple isochronous circuitry units each including one of said cores;
a system reference clock signal generator providing an output clock signal of a given frequency and phase; and
circuitry, associated with said system reference clock signal generator, that provides a plurality of related clock signals, each with said clock frequency but a different phase from said reference clock signal, each said related clock signals being provided to a different one of said units.

4. A reduced switching current induced problem electronic package, comprising:
a given plurality of partitions each containing circuitry that may be operationally switched at times different from circuitry in other partitions of said given plurality of partitions; and
a multiphase clock generator providing same frequency but different phase clock signals to each of said given plurality of partitions whereby switching operationally occurs at different times in each of said partitions.

5. A reduced switching current induced problem electronic package, comprising:
a given plurality of sets of circuitry wherein each set contains circuitry that may be operationally switched at times different from circuitry in other sets of said given plurality of sets; and
a multiphase clock generator providing same frequency but different phase clock signals to each of said given plurality of sets whereby switching operationally occurs at different times in said different sets.

6. The method of reducing switching current induced problems in an electronic package, comprising the steps of:
grouping at least some of the circuitry of the electronic package into a given plurality of sets; and
applying same frequency but different phase clock signals to each one of said given plurality of sets whereby switching operationally occurs at different times in each of said sets.

7. The method of claim 6 where the sets of circuitry are on different chips.

8. The method of claim 6 where at least one chip of the electronic package has a plurality of sets of circuitry operating with different phase switching clock signals.
